(19) United States
(12) Patent Application Publication
(10) Pub. No.: US 2025/0251738 A1
(43) Pub. Date: Aug. 7, 2025

(54) FOLLOWING METHOD AND FOLLOWING DEVICE OF MOBILE ROBOT BASED ON ELECTROMAGNETIC POSITIONING AND READABLE MEDIUM

(71) Applicant: Quanzhou Equipment Manufacturing Research Institute, Jinjiang City (CN)

(72) Inventors: Houde DAI, Jinjiang City (CN); Hanchen YAO, Jinjiang City (CN); Liqi ZHU, Jinjiang City (CN); Jianwei PENG, Jinjiang City (CN); Zhirong LIN, Jinjiang City (CN); Xuke XIA, Jinjiang City (CN); Yanglin LIAN, Jinjiang City (CN); Zengwei WANG, Jinjiang City (CN); Zhen ZHANG, Jinjiang City (CN)

(21) Appl. No.: 19/179,054

(22) Filed: Apr. 15, 2025

Related U.S. Application Data
(63) Continuation of application No. PCT/CN2023/085383, filed on Mar. 31, 2023.

(30) Foreign Application Priority Data
Oct. 20, 2022 (CN) 202211285737.3

(51) Int. Cl. G05D 1/686; G05D 1/247; G05D 101/15

(52) U.S. Cl. CPC G05D 1/686; G05D 1/247; G05D 2101/15

(57) ABSTRACT

A following method of a mobile robot based on electromagnetic positioning includes the following steps. Acquiring electromagnetic signals sent to one or more receiving modules by a transmitting module, and obtaining position and orientation information of the one or more receiving modules relative to the transmitting module; determining whether the mobile robot is in a single-person following mode or a multi-person following mode; following a single one of one or more pedestrian targets using a linear acceleration and an angular acceleration of the mobile robot when the mobile robot is determined to be in the single-person following mode; and finding an average value of the position and orientation information and following multiple of the one or more pedestrian targets using the linear acceleration and the angular acceleration of the mobile robot when the mobile robot is determined to be in the multi-person following mode.

### RELATED APPLICATIONS

This application is a continuation of International Patent Application PCT/CN2023/085383, filed on Mar. 31, 2023, which claims priority to Chinese Patent Application 202211285737.3, filed on Oct. 20, 2022. International Patent Application PCT/CN2023/085383 and Chinese Patent Application 202211285737.3 are incorporated herein by reference.

### FIELD OF THE DISCLOSURE

The present disclosure relates to the field of mobile following, and particularly relates to a following method and a following device of a mobile robot based on electromagnetic positioning and a readable medium.

### BACKGROUND OF THE DISCLOSURE

In scenarios of human-machine integration and collaboration, such as for accompanying physical movement support for elderly, children, and special groups, welcoming and guiding guests in exhibition halls, museums, etc., logistics sorting and handling, and restaurant food delivery, human-machine interaction actions, such as a following task of a mobile robot for human body targets, is required. In particular, detecting, locking, and tracking the specific human body targets in a multi-person, dynamic, and unstructured environments is required.

The mobile robot identifies and follows one or more pedestrian targets through sensors. The mobile robot comprises two modes: a tracked human body wearing transceiver modules and the tracked human body without the transceiver modules. The mode of the tracked human body without the transceiver modules mainly comprises a camera sensor and a lidar sensor. The camera sensor depends on a light intensity of an environment and loses a following target in strong light and weak light. Features input by the lidar sensor are sparse, and it is difficult to achieve stable target recognition in scenes with multiple people and complex obstacles. The mode of the tracked human body wearing the transceiver modules mainly comprises Bluetooth, ultra-wideband (UWB) sensors, and electromagnetic sensors. As the best way, the transceiver modules are respectively disposed on the mobile robot and the tracked human body, and the transceiver modules are connected wirelessly. For the Bluetooth and the UWB sensors, a communication distance is short, and attenuation is large when crossing obstacles, so that signals are lost in multi-person scenarios. The electromagnetic sensors can achieve accurate 360° position and orientation tracking without optical obstacles and can achieve a large tracking range by adjusting magnetic field strength. Two or more people can be tracked at the same time through multiple of the transceiver modules.

A following method and a following system of the mobile robot using electromagnetic positioning have the following difficulties.

(1) A tracking distance of a wireless electromagnetic tracking method based on a permanent magnet used as a signal source is limited by a rapid attenuation of a static magnetic field strength.

(2) An alternating electromagnetic tracking method is limited by a wired connection of transceiver ends. The alternating electromagnetic tracking method with wireless connection of the transceiver ends has not been effectively applied in following robots.

### BRIEF SUMMARY OF THE DISCLOSURE

With respect to the above-mentioned deficiencies existing in perception and tracking of the existing following robots, especially difficulty with stably and reliably tracking person targets in outdoor and multi-person environments, an objective of the embodiments of the present disclosure is to provide a following method and a following device of a mobile robot based on electromagnetic positioning and a readable medium to solve the technical problems mentioned in the background.

On a first aspect, the present disclosure discloses a following method of a mobile robot based on electromagnetic positioning, the following method comprises the following steps.

Step 1. acquiring electromagnetic signals sent to one or more receiving modules located on one or more pedestrian targets by a transmitting module located on the mobile robot, and obtaining position and orientation information of the one or more receiving modules relative to the transmitting module by calculating through an electromagnetic positioning algorithm based on the electromagnetic signals.

Step 2. determining whether the mobile robot is in a single-person following mode or a multi-person following mode based on a number of connection signals of the one or more receiving modules connected to the transmitting module.

Step 3. following a single one of the one or more pedestrian targets using a linear acceleration and an angular acceleration of the mobile robot obtained by calculating using a following motion control algorithm of the mobile robot based on the position and orientation information of the one or more receiving modules relative to the transmitting module when the mobile robot is determined to be in the single-person following mode.

Step 4. finding an average value of the position and orientation information of multiple of the one or more receiving modules relative to the transmitting module and following multiple of the one or more pedestrian targets using the linear acceleration and the angular acceleration of the mobile robot obtained by calculating using the following motion control algorithm of the mobile robot based on the average value when the mobile robot is determined to be in the multi-person following mode.

Preferably, the step 1 comprises:

Defining a center of the transmitting module as an origin of a coordinate system of the transmitting module, obtaining three orthogonal magnetic induction intensity components (Bₓ, B_{y}, B_{z}) by measuring through the one or more receiving modules, wherein a coordinate system of the one or more receiving modules is parallel to three coordinate axes of the coordinate system of the transmitting module, and obtaining a first target coordinate system (u, v, w) by rotating a second target coordinate system (x, y, z) around an x-axis, a y-axis, and a z-axis by Euler angles α, β, and γ respectively, wherein a rotation direction is counterclockwise from top to bottom in each of the x-axis, the y-axis, and the z-axis.

Obtaining the three orthogonal magnetic induction intensity components (Bₓ, B_{y}, B_{z}) by calculating based on a magnetic dipole model:

$$\{ \begin{matrix}{B}_{x} = {B}_{T} \{ 3 x ( mx + ny + pz ) / {r}^{5} - m / {r}^{3} \} \\ {B}_{y} = {B}_{T} \{ 3 y ( mx + ny + pz ) / {r}^{5} - n / {r}^{3} \} \\ {B}_{z} = {B}_{T} \{ 3 z ( mx + ny + pz ) / {r}^{5} - p / {r}^{3} \}\end{matrix} .$$

B_{T} is a constant, B_{T}=μIR²/4, μ is a magnetic permeability of air, I is magnitude of current, R is a radius of one or more coils of the transmitting module, (m, n, p) are unit direction vectors of the transmitting module, m²+n²+p²=1, r is a distance from the one or more receiving modules to the transmitting module, and r=\sqrt{x²+y²+z²}.

Obtaining magnetic induction intensity components (Bᵤ, B_{y}, B_{w}) induced by the one or more receiving modules in the first target coordinate system (u, v, w) based on the three orthogonal magnetic induction intensity components (Bₓ, B_{y}, B_{z}) by calculating:

(Bᵤ,Bᵥ,B_{w})^{T}=R(Bₓ,B_{y},B_{z})^{T}.

R is the Euler angle, and a rotation process is described as follows:

R=Rot(z,γ)Rot(y,β)Rot(x,α).

Rot(z, γ) is rotating around the z axis by an angle γ, Rot(y, β) is rotating around the y axis by an angle β, and Rot(x, α) is rotating around the x axis by an angle α.

Obtaining the position and orientation information of the one or more receiving modules relative to the transmitting module through the electromagnetic positioning algorithm by calculating based on the magnetic induction intensity components (Bᵤ, Bᵥ, B_{w}) induced by the one or more receiving modules in the first target coordinate system (u, v, w).

Preferably, the electromagnetic positioning algorithm comprises an optimization algorithm, an analytical method, or a wireless tracking algorithm based on a neural network.

Preferably, the step 2 comprises:

Determining whether the mobile robot is in the single-person following mode or the multi-person following mode by checking the number of the connection signals of the one or more receiving modules connected to the transmitting module.

When the number of the connection signals is 1, determining that the mobile robot is in the single-person following mode and executing the step 3.

When the number of the connection signals is greater than 1, determining that the mobile robot is in the multi-person following mode, and executing the step 4.

Preferably, the step 3 comprises:

Step 31. computing a state vector of the mobile robot in a world coordinate system as follows:

xᵣ^{W}=[xᵣ yᵣ θᵣ]^{T}.

Computing a state vector of the one or more pedestrian targets in the world coordinate system as follows:

xₕ^{W}=[xₕ yₕ θₕ]^{T}

Computing a state vector of the mobile robot in a pedestrian coordinate system as follows:

xᵣ^{H}=[xₑ yₑ θₑ]^{T}

Calculating an angle of the mobile robot converted from the world coordinate system to the pedestrian coordinate system as follows:

$${x}_{r}^{H} = F ( {x}_{r}^{W} - {x}_{h}^{W} - {[ \begin{matrix}0 & 0 & {θ}_{sh}\end{matrix} ]}^{T} ) .$$

Determining a conversion matrix F as follows:

$$F = [ \begin{matrix}cos ( {θ}_{h} + {θ}_{sh} ) & sin ( {θ}_{h} + {θ}_{sh} ) & 0 \\ - sin ( {θ}_{h} + {θ}_{sh} ) & cos ( {θ}_{h} + {θ}_{sh} ) & 0 \\ 0 & 0 & 1\end{matrix} ] .$$

Obtaining one or more distances d and one or more angles Φ between the one or more receiving modules and the transmitting module by calculating using the following motion control algorithm of the mobile robot based on the state vector of the mobile robot in the pedestrian coordinate system.

Step 32. judging quadrant information of the single one of the one or more pedestrian targets relative to the mobile robot based on a corresponding one of the one or more angles Φ between a corresponding one of the one or more receiving modules and the transmitting module, and judging a following mode by the quadrant information:

$$Φ = \frac{{\sum }_{i = 1}^{N} {Φ}_{i}}{N} = \{ \begin{matrix}[ π / 4 , 3 π / 4 ] , rear follow mode \\ [ 3 π / 4 , π ] ⋃ [ - π , - 3 π / 4 ] , right follow mode \\ [ - 3 π / 4 , - π / 4 ] , front follow mode \\ [ - π / 4 , 0 ] ⋃ [ 0 , π / 4 ] , left follow mode\end{matrix} .$$

When Φ=[π/4, 3π/4], judging that the mobile robot is at a rear side of the single one of the one or more pedestrian targets and triggering a rear following mode in which an input linear acceleration aᵥ and an input angular acceleration a_{w} are controlled by a step 33 to enable Φ to tend to π/2.

When Φ=[3π/4, π]∪[−π, −3π/4], judging that the mobile robot is at a right side of the single one of the one or more pedestrian targets and triggering a right following mode in which the input linear acceleration aᵥ and the input angular acceleration a_{w} are controlled by the step 33 to enable Φ to tend to x.

When Φ=[−3π/4, −π/4], judging that the mobile robot is at a front side of the single one of the one or more pedestrian targets and triggering a front following mode in which the input linear acceleration aᵥ and the input angular acceleration a_{w} are controlled by the step 33 to enable Φ to tend to −π/2.

When Φ=[−π/4, 0]∪[0, π/4], judging that the mobile robot is at a left side of the single one of the one or more pedestrian targets and triggering a left following mode in which the input linear acceleration aᵥ and the input angular acceleration a_{w} are controlled by the step 33 to enable Φ to tend to 0.

Step 33. obtaining the input linear acceleration aᵥ and the input angular acceleration a_{w} by calculating using the following motion control algorithm of the mobile robot based on a relative position and orientation between the mobile robot and the single one of the one or more pedestrian targets, an environmental perception information, and a human-computer interaction strategy, wherein the following motion control algorithm of the mobile robot comprises a force control algorithm of a virtual spring, a social force model/impedance control algorithm, a model predictive control algorithm, or a reinforcement learning algorithm.

Preferably, when the following motion control algorithm of the mobile robot adopts the force control algorithm of the virtual spring, assume that there is a connection of an origin of the pedestrian coordinate system and a coordinate of the mobile robot between the mobile robot and the one or more pedestrian targets xᵣ^{H}=[xₑ yₑ θₑ]^{T}, a relaxation length of the virtual spring is a corresponding one of the one or more distances d between the mobile robot and the corresponding one of the one or more receiving modules, and a corresponding one of the one or more angles between the mobile robot and the corresponding one of the one or more receiving modules are Φ, which is illustrated as follows:

$$\{ \begin{matrix}d = \sqrt{{x}_{e}^{2} + {y}_{e}^{2}} \\ Φ = arc tan \frac{{y}_{e}}{{x}_{e}}\end{matrix} .$$

The method comprises describing a following relationship between the mobile robot and the single one of the one or more pedestrian targets as a force of the virtual spring, and obtaining a virtual tensile and compressive deformation elastic force F₁ and a virtual bending deformation elastic force F₂ by calculating:

$$\{ \begin{matrix}{F}_{1} = {k}_{1} ( d - {l}_{0} ) \\ {F}_{2} = {k}_{2} / Φ\end{matrix} .$$

k₁ is an elastic coefficient of the virtual spring with units in N/m, k₂ is a curvature coefficient of the virtual spring with units in N/rad, and l₀ is an initial length of the virtual spring with units in m;
A dynamic equation of the following motion control is illustrated as follows:

$$\{ \begin{matrix}{Ma}_{v} = - {F}_{1} cos ( {θ}_{e} - Φ ) - {F}_{2} sin ( {θ}_{e} - Φ ) - {k}_{3} v \\ {Ma}_{ω} = ( {F}_{1} sin ( {θ}_{e} - Φ ) + {F}_{2} cos ( {θ}_{e} - Φ ) - {k}_{4} ω ) L\end{matrix} .$$

M is a mass of the mobile robot with units in Kg, k₃ is a translational damping coefficient with units in Ns/m, and k₄ is a rotational damping coefficient with units in Ns/rad.

A following motion controller is illustrated as follows:

$$[ \begin{matrix}{a}_{v} \\ {a}_{ω}\end{matrix} ] = [ \begin{matrix}- \frac{{k}_{3}}{M} & 0 \\ 0 & - \frac{{k}_{4} L}{I}\end{matrix} ] [ \begin{matrix}v \\ ω\end{matrix} ] + [ \begin{matrix}- \frac{{F}_{1}}{M} cos ( {θ}_{e} - Φ ) - \frac{{F}_{2}}{M} sin ( {θ}_{e} - Φ ) \\ ( {F}_{1} sin ( {θ}_{e} - Φ ) + {F}_{2} cos ( {θ}_{e} - Φ ) - \frac{L}{I} )\end{matrix} ] .$$

I is a moment of inertia of the mobile robot, θₑ is an angle of the mobile robot in the pedestrian coordinate system, and a front following function, a rear following function, and a side following function of the mobile robot relative to the single one of the one or more pedestrian targets is configured to be achieved by controlling a real-time angle Φ between the mobile robot and the single one of the one or more pedestrian targets to tend to De using the following motion controller.

Preferably, the step 4 comprises:

repeating the step 31, respectively obtaining the corresponding one of the one or more distances d and the corresponding one of the one or more angles Φ between the corresponding one of the one or more receiving modules on each of the multiple of the one or more pedestrian targets and the transmitting module by calculating, obtaining an average angle by deriving an average value, and repeating steps 32 and 33 to realize a front following function, a rear following function, and a side following function of the multiple of the one or more pedestrian targets based on the average angle.

On a second aspect, the present disclosure discloses a following device of a mobile robot based on electromagnetic positioning, the following device comprises a position and orientation information acquisition module, a following mode determination module, a single-person following control module, and a multi-person following control module.

The position and orientation information acquisition module is configured to acquire electromagnetic signals sent to one or more receiving modules located on one or more pedestrian targets from a transmitting module located on the mobile robot and to obtain position and orientation information of the one or more receiving modules relative to the transmitting module by calculating using an electromagnetic positioning algorithm based on the electromagnetic signals.

The following mode determination module is configured to determine whether the mobile robot is in a single-person following mode or a multi-person following mode based on a number of connection signals of the one or more receiving modules connected to the transmitting module.

The single-person following control module is configured to follow a single one of the one or more pedestrian targets using a linear acceleration and an angular acceleration of the mobile robot obtained by calculating using a following motion control algorithm of the mobile robot based on position and orientation information of the one or more receiving modules relative to the transmitting module when the mobile robot is determined to be in the single-person following mode.

The multi-person following control module is configured to find an average value of the position and orientation information of multiple of the one or more receiving modules relative to the transmitting module and follow multiple of the one or more pedestrian targets using the linear acceleration and the angular acceleration of the mobile robot obtained by calculating using the following motion control algorithm of the mobile robot based on the average value when the mobile robot is determined to be in the multi-person following mode.

On a third aspect, the present disclosure discloses an electronic device, the electronic device comprises one or more processors and a storage device for storing one or more computer programs, when the one or more computer programs are executed by the one or more processors, the method according to any implementation in the first aspect is implemented by the one or more processors.

On a fourth aspect, the present disclosure discloses a non-transitory computer-readable storage medium, a computer program is stored on the non-transitory computer-readable storage medium, and the method according to any implementation in the first aspect is implemented when the computer program is executed by a processor.

Compared with the existing techniques, the technical solution of the present disclosure has the following advantages.

(1) The present disclosure adopts electromagnetic tracking technology (e.g., wireless alternating electromagnetic tracking technology) to achieve accurate 360° position and orientation tracking without optical obstacles and can simultaneously track one, two, or more people, enabling human body tracking to be more accurate and stable. At the same time, by integrating the electromagnetic tracking technology (e.g., the wireless alternating electromagnetic tracking technology) with inertial sensing, motion states of the mobile robot and the tracked human body can be more completely perceived and predicted. In terms of control strategy, an adaptive motion mode for walking paths and human-machine collaboration scenarios is achieved by combining intelligent control algorithms, such as a force control algorithm of a virtual spring, a social force model/impedance control algorithm, a model predictive control algorithm, or a reinforcement learning algorithm.

(2) In the present disclosure, a function of following one or more pedestrian targets of the mobile robot with more accurate recognition, longer distance, and better stability is achieved by wearing one or more receiving modules of an electromagnetic sensor on the one or more pedestrian targets and installing a transmitting module of the electromagnetic sensor on the mobile robot. Recognition and following of the one or more pedestrian targets in scenes with multiple people and complex obstacles can also be achieved by the mobile robot.

(3) The present disclosure greatly improves practicality and intelligence levels of the following robot, and the following robot is expected to be widely used in daily life, and creates good conditions for further human-machine interaction in a human-machine integration environment.

### BRIEF DESCRIPTION OF THE DRAWINGS

In order to illustrate the technical solutions in the embodiments of the present disclosure more clearly, the drawings required for the description of the embodiments are briefly introduced below. It is obvious that the drawings described below are merely some embodiments of the present disclosure. Other drawings can be obtained based on these drawings by person of ordinary skill in the art without creative works.

FIG. 1 illustrates a view of an exemplary device architecture in which an embodiment of the present disclosure can be used;

FIG. 2 illustrates a flowchart of a following method of a mobile robot based on electromagnetic positioning in the embodiment of the present disclosure;

FIG. 3 illustrates a work flowchart of a transmitting module and one or more receiving modules of the electromagnetic positioning in the following method of the mobile robot based on the electromagnetic positioning in the embodiment of the present disclosure;

FIG. 4 illustrates a functional demonstration graph of the following method of the mobile robot based on the electromagnetic positioning in the embodiment of the present disclosure;

FIG. 5 illustrates a diagrammatic view the following method of mobile robot based on the electromagnetic positioning in the embodiment of the present disclosure in which an (x, y, z) coordinate system is converted into a (u, v, w) coordinate system through Euler angles;

FIG. 6 illustrates a diagrammatic view of four following modes for a single-person target using the following method of the mobile robot based on the electromagnetic positioning of the embodiment of the present disclosure;

FIG. 7 illustrates a diagrammatic view of following motion control of a two-wheeled differential-type mobile robot using the following method of the mobile robot based on the electromagnetic positioning of the embodiment of the present disclosure;

FIG. 8 illustrates a diagrammatic view of four following modes for a two-person target using the following method of the mobile robot based on the electromagnetic positioning of the embodiment of the present disclosure;

FIG. 9 illustrates a diagrammatic of a following device of the mobile robot based on the electromagnetic positioning of the embodiment of the present disclosure; and

FIG. 10 illustrates a structural diagrammatic view of a computer device of an electronic device suitable for implementing the embodiment of the present disclosure.

### DETAILED DESCRIPTION OF THE EMBODIMENTS

In order to allow a purpose, technical solutions, and advantages of the present disclosure to be clearer, the present disclosure will be further described below in conjunction with the accompanying drawings. It is obvious that the described embodiments are merely some of the embodiments of the present disclosure instead of all of the embodiments. All other embodiments fall into the protection scope of the present disclosure provided that they are obtained based on the embodiments of the present disclosure by person of ordinary skill in the art without creative works.

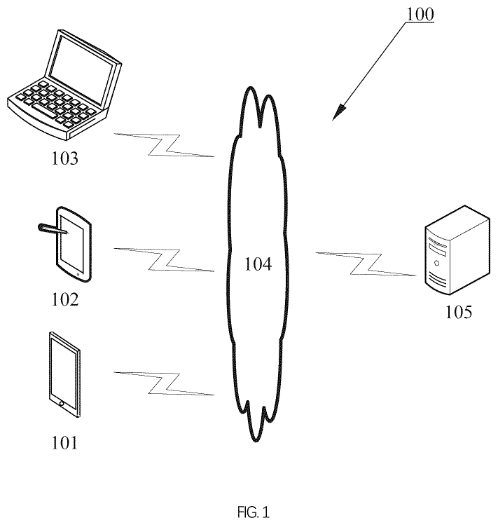

FIG. 1 illustrates an exemplary device architecture 100 in which a following method of a mobile robot based on electromagnetic positioning or a following device of the mobile robot based on the electromagnetic positioning of the embodiment of the present disclosure can be used.

As shown in FIG. 1, the exemplary device architecture 100 can comprise terminal devices 101, 102, and 103, a network 104, and a server 105. The network 104 is used to provide a medium for a communication link between the terminal devices 101, 102, and 103 and the server 105. The network 104 can comprise various connection types, such as wired or wireless communication links or optical fiber cables.

The users can use the terminal devices 101, 102, and 103 to interact with the server 105 through the network 104 to receive or transmit messages, etc. Various applications can be installed on the terminal devices 101, 102, and 103, such as data processing applications or file processing applications.

The terminal devices 101, 102, and 103 can be hardware or software. When the terminal devices 101, 102, and 103 are the hardware, the terminal devices 101, 102, and 103 can be various electronic devices, which comprise but are not limited to smartphones, tablet computers, laptop portable computers, desktop computers, etc. When the terminal devices 101, 102, and 103 are the software, the software can be installed in the electronic devices listed above. It can be implemented as multiple elements of software or software modules (for example, the software or the software modules used to provide distributed services), or as a single software element or a software module. A specific limitation is not described herein.

The server 105 can be a server that provides various services, such as a background data processing server that processes files or data uploaded by the terminal devices 101, 102, and 103. The background data processing server can process acquired files or data and generate processing results.

It should be noted that the following method of the mobile robot based on the electromagnetic positioning of the embodiment of the present disclosure can be executed by the server 105 or by the terminal devices 101, 102, and 103. Correspondingly, the following device of the mobile robot based on the electromagnetic positioning can be disposed in the server 105 or the terminal devices 101, 102, and 103.

It should be understood that a number of the terminal devices, the network, and the server in FIG. 1 is merely for illustration. There can be any number of the terminal devices, the network, and the server according to implementation requirements. In a case where processed data does not need to be acquired remotely, the aforementioned device architecture merely needs the server or the terminal devices without the network.

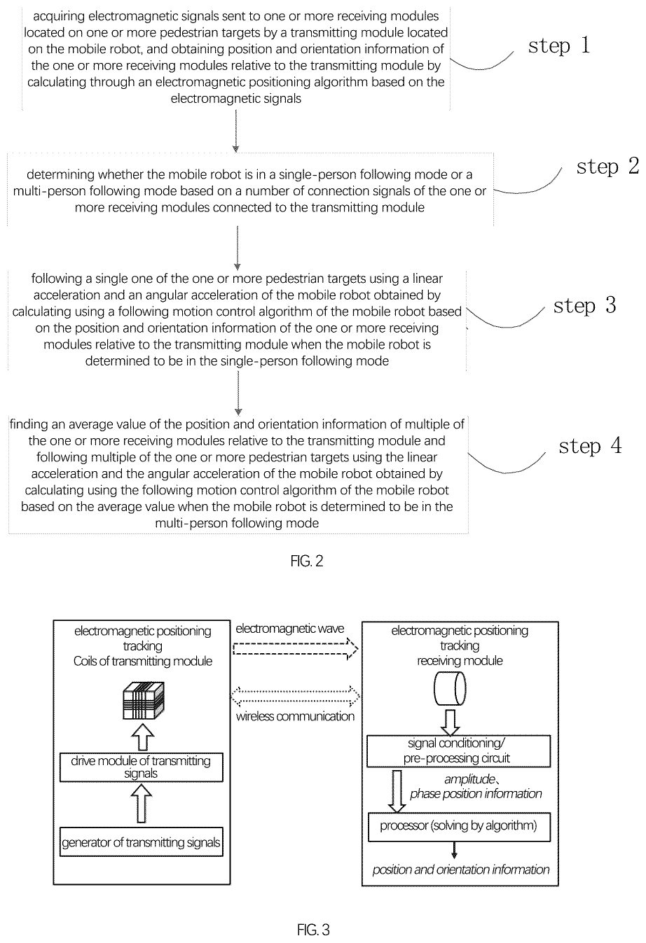

FIG. 2 shows the following method of the mobile robot based on the electromagnetic positioning of the embodiment of the present disclosure, the following method comprises the following steps:

Step 1. acquiring electromagnetic signals sent to one or more receiving modules located on one or more pedestrian targets by a transmitting module located on the mobile robot, and obtaining position and orientation information of the one or more receiving modules relative to the transmitting module by calculating through an electromagnetic positioning algorithm based on the electromagnetic signals;

In a specific embodiment, the step 1 specifically comprises:

Defining a center of the transmitting module as an origin of a coordinate system of the transmitting module, obtaining three orthogonal magnetic induction intensity components (Bₓ, B_{y}, B_{z}) by measuring through the one or more receiving modules, wherein a coordinate system of the one or more receiving modules is parallel to three coordinate axes of the coordinate system of the transmitting module, and obtaining a first target coordinate system (u, v, w) by rotating a second target coordinate system (x, y, z) around an x-axis, a y-axis, and a z-axis by Euler angles α, β, and γ respectively, wherein a rotation direction is counterclockwise from top to bottom in each of the x-axis, the y-axis, and the z-axis;

Obtaining the three orthogonal magnetic induction intensity components (Bₓ, B_{y}, B_{z}) by calculating based on a magnetic dipole model:

$$\{ \begin{matrix}{B}_{x} = {B}_{T} \{ 3 x ( mx + ny + pz ) / {r}^{5} - m / {r}^{3} \} \\ {B}_{y} = {B}_{T} \{ 3 y ( mx + ny + pz ) / {r}^{5} - n / {r}^{3} \} \\ {B}_{z} = {B}_{T} \{ 3 z ( mx + ny + pz ) / {r}^{5} - p / {r}^{3} \}\end{matrix} .$$

In the formula, Bris a constant, B_{T}=μIR²/4, μ is a magnetic permeability of air, I is magnitude of current, and R is a radius of one or more coils of the transmitting module; (m, n, p) are unit direction vectors of the transmitting module, and m²+n²+p²=1; and r is a distance from the one or more receiving modules to the transmitting module, and r=\sqrt{x²+y²+z²}.

Obtaining magnetic induction intensity components (Bᵤ, Bᵥ, B_{w}) induced by the one or more receiving modules in the first target coordinate system (u, v, w) based on the three orthogonal magnetic induction intensity components (Bₓ, B_{y}, B_{z}) by calculating: (Bᵤ, Bᵥ, B_{w})^{T}=R(Bₓ,B_{y},B_{z}).

In the formula, R is the Euler angle, and a rotation process is described as follows:

R=Rot(z,γ)Rot(y,β)Rot(x,α)

In the formula, Rot(z, γ) is rotating around the z axis by an angle γ, Rot(y, β) is rotating around the y axis by an angle β, and Rot(x, α) is rotating around the x axis by an angle α;

Obtaining the position and orientation information of the one or more receiving modules relative to the transmitting module through the electromagnetic positioning algorithm by calculating based on the magnetic induction intensity components (Bᵤ, Bᵥ) B_{w}) induced by the one or more receiving modules in the first target coordinate system (u, v, w).

In a specific embodiment, the electromagnetic positioning algorithm comprises an optimization algorithm, an analytical method, or a wireless tracking algorithm based on a neural network.

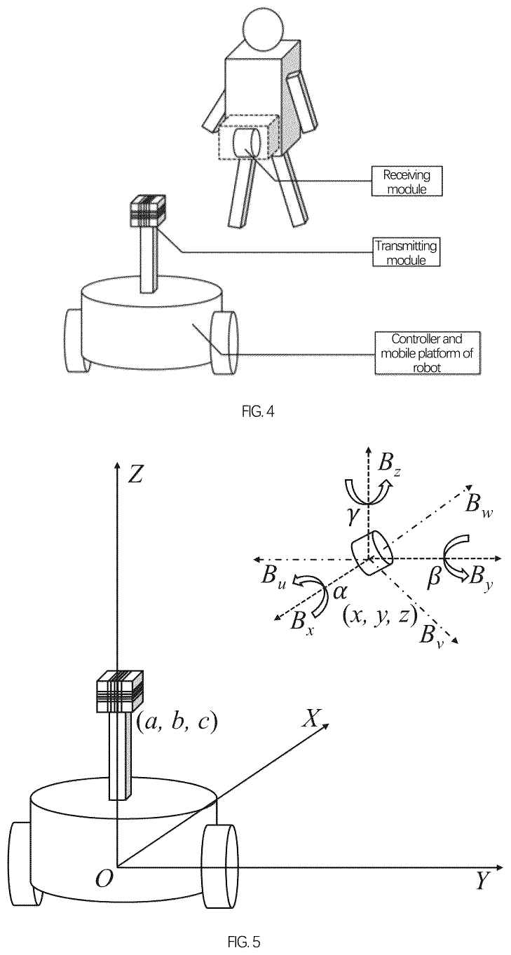

Specifically, referring to FIGS. 3 and 4, the transmitting module configured for electromagnetic positioning is placed on the mobile robot, and the one or more pedestrian targets to be followed wear the one or more receiving modules configured for the electromagnetic positioning. The transmitting module can adopt a single-axis to multi-axis coil mode, the one or more receiving modules adopt a corresponding multi-axis to single-axis coil mode, and the transmitting module is placed at a center of the mobile robot. The one or more receiving modules can be placed at any part of the one or more pedestrian targets due to benefiting from abilities of 360-degree all-round scanning, long-distance detection, and detecting electromagnetic wave signals penetrating obstacles of an electromagnetic sensor. Referring to FIG. 5, in a motion process in which the mobile robot follows the one or more pedestrian targets, the one or more receiving modules are usually in a non-orthogonal orientation. The magnetic induction intensity components induced by the one or more receiving modules in the coordinate system (u, v, w) are (Bᵤ, B_{y}, B_{w}). The position and orientation (xₕ, yₕ, zₕ, αₕ, βₕ, γₕ) of the one or more receiving modules of the one or more pedestrian targets at a time t are obtained by calculating through the electromagnetic positioning algorithm. As there are two or more transmitting coils (with different transmitting frequencies), each of the two or more transmitting coils is equivalent to a corresponding one of magnetic dipoles, and a received signal is superposition of signals of the magnetic dipoles with the different transmitting frequencies. A total number of axes of the received signal is greater than 5. The position and orientation information of the one or more receiving modules relative to the transmitting module can be obtained through the analytical method, the optimization algorithm, or the wireless tracking algorithm based on the neural network. A symbolic solution of the position and orientation of the one or more receiving modules is achieved by eliminating a phase-locked loop ambiguity (XY axis) and a hemisphere ambiguity (Z axis). Improvements in tracking accuracy and performance of the position and orientation are achieved through a calibration algorithm. It should be noted that the analytical method, the optimization algorithm, and the wireless tracking algorithm based on the neural network are existing mature algorithms and will not be further described herein.

In addition, tasks such as better tracking, obstacle avoidance, and path planning can be achieved by integrating wireless electromagnetic tracking technologies with a visible light camera, an infrared thermal imaging, lidar, millimeter-wave radar, ultrasonic arrays, etc.

Step 2. determining whether the mobile robot is in a single-person following mode or a multi-person following mode based on a number of connection signals of the one or more receiving modules connected to the transmitting module.

In a specific embodiment, the step 2 specifically comprises:

Determining whether the mobile robot is in the single-person following mode or the multi-person following mode by checking the number of the connection signals of the one or more receiving modules connected to the transmitting module;

When the number of the connection signals is 1, the mobile robot is determined in the single-person following mode, and step 3 is executed. When the number of the connection signals is greater than 1, the mobile robot is determined in the multi-person following mode, and step 4 is executed.

Specifically, the mobile robot can follow at least one of the one or more pedestrian targets, that is, the transmitting module can send the electromagnetic signals to at least one of the one or more receiving modules. The number of the connection signals of the one or more receiving modules connected to the transmitting module can be used to determine whether the one or more pedestrian targets followed by the mobile robot is a single person or multiple people, and control steps of following motions of the mobile robot are different according to a number of people.

Step 3. Following a single one of the one or more pedestrian targets using a linear acceleration and an angular acceleration of the mobile robot obtained by calculating using a following motion control algorithm of the mobile robot based on the position and orientation information of the one or more receiving modules relative to the transmitting module when the mobile robot is determined to be in the single-person following mode.

In a specific embodiment, the step 3 specifically comprises:

Step 31. a state vector of the mobile robot in a world coordinate system is computed as follows:

xᵣ^{W}=[xᵣ yᵣ θᵣ]^{T}.

A state vector of the one or more pedestrian targets in the world coordinate system is computed as follows:

xₕ^{W}=[xₕ yₕ θₕ]^{T}.

A state vector of the mobile robot in a pedestrian coordinate system E is computed as follows:

xᵣ^{H}=[xₑ yₑ θₑ]^{T}.

An angle of the mobile robot converted from the world coordinate system to the pedestrian coordinate system E is calculated as follows:

$${x}_{r}^{H} = F ( {x}_{r}^{W} - {x}_{h}^{W} - {[ \begin{matrix}0 & 0 & {θ}_{sh}\end{matrix} ]}^{T} ) .$$

A conversion matrix F is determined as follows:

$$F = [ \begin{matrix}cos ( {θ}_{h} + {θ}_{sh} ) & sin ( {θ}_{h} + {θ}_{sh} ) & 0 \\ - sin ( {θ}_{h} + {θ}_{sh} ) & cos ( {θ}_{h} + {θ}_{sh} ) & 0 \\ 0 & 0 & 1\end{matrix} ] .$$

One or more distances d and one or more angles Φ between the one or more receiving modules and the transmitting module is obtained by calculating using the following motion control algorithm of the mobile robot based on the state vector of the mobile robot in the pedestrian coordinate system E.

Step 32. judging quadrant information of the single one of the one or more pedestrian targets relative to the mobile robot based on a corresponding one of the one or more angles Φ between a corresponding one of the one or more receiving modules and the transmitting module, and judging a following mode by the quadrant information:

$$Φ = \frac{{\sum }_{i = 1}^{N} {Φ}_{i}}{N} = \{ \begin{matrix}[ π / 4 , 3 π / 4 ] , rear follow mode \\ [ 3 π / 4 , π ] ⋃ [ - π , - 3 π / 4 ] , right follow mode \\ [ - 3 π / 4 , - π / 4 ] , front follow mode \\ [ - π / 4 , 0 ] ⋃ [ 0 , π / 4 ] , left follow mode\end{matrix} .$$

When Φ=[π/4, 3π/4], it is judged that the mobile robot is at a rear side of the single one of the one or more pedestrian targets and a rear following mode is triggered, an input linear acceleration aᵥ and an input angular acceleration a_{w} are controlled by a step 33 to enable Φ to tend to π/2.

When Φ=[3π/4, π]∪[−π, −3π/4], it is judged that the mobile robot is at a right side of the single one of the one or more pedestrian targets and a right following mode is triggered, the input linear acceleration aᵥ and the input angular acceleration a_{w} are controlled by the step 33 to enable Φ to tend to π.

When Φ=[−3π/4, −π/4], it is judged that the mobile robot is at a front side of the single one of the one or more pedestrian targets and a front following mode is triggered, the input linear acceleration aᵥ and the input angular acceleration a_{w} are controlled by the step 33 to enable Φ to tend to −π/2.

When Φ=[−π/4, 0]∪[0, π/4], it is judged that the mobile robot is at a left side of the single one of the one or more pedestrian targets and a left following mode is triggered, the input linear acceleration aᵥ and the input angular acceleration a_{w} are controlled by the step 33 to enable Φ to tend to 0.

Step 33. obtaining the input linear acceleration aᵥ and the input angular acceleration a_{w} by calculating using the following motion control algorithm of the mobile robot based on a relative position and orientation between the mobile robot and the single one of the one or more pedestrian targets, an environmental perception information, and a human-computer interaction strategy. The following motion control algorithm of the mobile robot comprises a force control algorithm of a virtual spring, a social force model/impedance control algorithm, a model predictive control algorithm, or a reinforcement learning algorithm.

Specifically, six-dimensional relative position and orientation (xₕ, yₕ, zₕ, αₕ, βₕ, γₕ) of the one or more receiving modules (the one or more pedestrian targets) relative to the transmitting module are obtained by estimating through the electromagnetic positioning algorithm. At this time, the center of the transmitting module is located at a coordinate zero point (0, 0, 0, 0, 0, 0). With respect to scenes, such as that the mobile robot is moving in a plane section, merely three-dimensional position and orientation information (xₕ, yₕ, zₕ) are required to achieve following guidance.

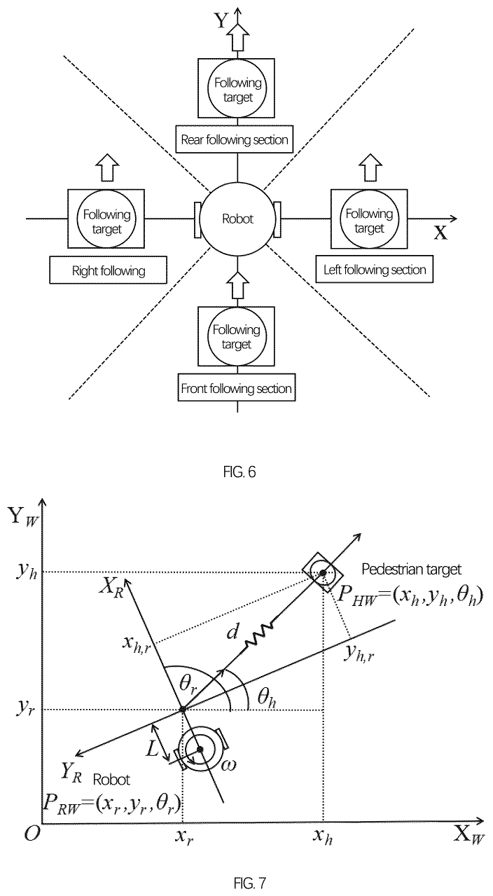

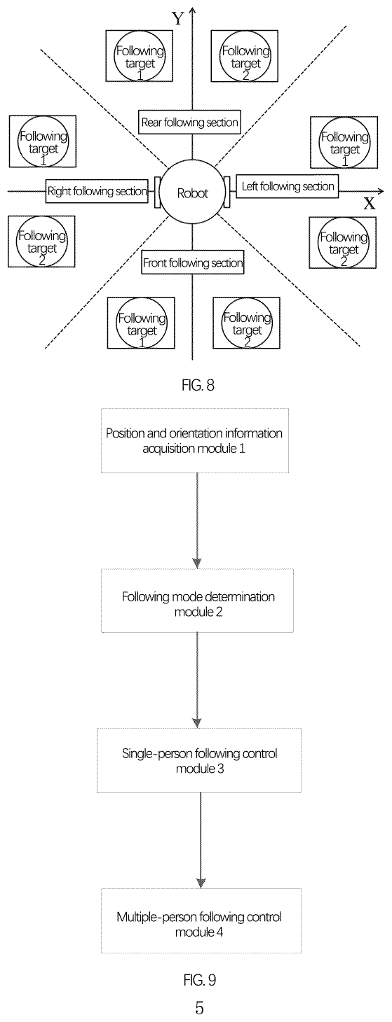

The mobile robot can adopt a bipedal, dual-wheel differential type, three-wheel or multi-wheel differential speed, or tripedal or multipedal mobile platform and has basic functions of the mobile robot, such as energy management, motion control, and the obstacle avoidance. Further, the quadrant information of the one or more pedestrian targets relative to the mobile robot (i.e., the front side, the rear side, the left side, the right side) is determined to determine the following modes according to the position and orientation information of the one or more receiving modules (the one or more pedestrian targets). Referring to FIG. 6, there are four of the following modes for the single-person target, namely, the front following mode, the rear following mode, the left following mode, and the right following mode. A human-machine following model is constructed based on a positional relationship between the mobile robot and the one or more pedestrian targets, and the following motion control algorithm of the mobile robot is designed based on the position and orientation information of the one or more pedestrian targets (xₕ, yₕ, θₕ) and the position and orientation information of the mobile robot (xᵣ, yᵣ, θᵣ). FIG. 7 illustrates a diagrammatic view of a following motion control for a two-wheel differential-type mobile robot. A motion control method needs to be adjusted accordingly to correspond to four-wheel and other driving methods.

In one embodiment, when the following motion control algorithm of the mobile robot adopts the force control algorithm of the virtual spring, it can be assumed that there is a connection of an origin and the pedestrian coordinate system E a coordinate of the mobile robot between the mobile robot and the one or more pedestrian targets xᵣ^{H}=[xₑ yₑ θₑ]^{T}, a relaxation length of the virtual spring is a corresponding one of the one or more distances d between the mobile robot and the single one of the one or more pedestrian targets (i.e., the corresponding one of the one or more receiving modules), and a corresponding one of the one or more angles between the mobile robot and the corresponding one of the one or more pedestrian targets (i.e., the one or more receiving modules) is Φ, which is illustrated as follows:

$$\{ \begin{matrix}d = \sqrt{{x}_{e}^{2} + {y}_{e}^{2}} \\ Φ = arc tan \frac{{y}_{e}}{{x}_{e}}\end{matrix} .$$

A following relationship between the mobile robot and the single one of the one or more pedestrian targets can be described as a force of the virtual spring, and a virtual tensile and compressive deformation elastic force F₁ and a virtual bending deformation elastic force F₂ can be obtained by calculation;

$$\{ \begin{matrix}{F}_{1} = {k}_{1} ( d - {l}_{0} ) \\ {F}_{2} = {k}_{2} / Φ\end{matrix} .$$

k₁ is an elastic coefficient of the virtual spring with units in N/m, k₂ is a curvature coefficient of the virtual spring with units in N/rad, and l₀ is an initial length of the virtual spring with units in m.

A dynamic equation of the following motion control is illustrated as follows:

$$\{ \begin{matrix}{Ma}_{v} = - {F}_{1} cos ( {θ}_{e} - Φ ) - {F}_{2} sin ( {θ}_{e} - Φ ) - {k}_{3} v \\ {Ma}_{ω} = ( {F}_{1} sin ( {θ}_{e} - Φ ) + {F}_{2} cos ( {θ}_{e} - Φ ) - {k}_{4} ω ) L\end{matrix} .$$

M is a mass of the mobile robot with units in Kg, k₃ is a translational damping coefficient with units in Ns/m, and k₄ is a rotational damping coefficient with units in Ns/rad.

A following motion controller is illustrated as follows:

$$[ \begin{matrix}{a}_{v} \\ {a}_{ω}\end{matrix} ] = [ \begin{matrix}- \frac{{k}_{3}}{M} & 0 \\ 0 & - \frac{{k}_{4} L}{I}\end{matrix} ] [ \begin{matrix}v \\ ω\end{matrix} ] + [ \begin{matrix}- \frac{{F}_{1}}{M} cos ( {θ}_{e} - Φ ) - \frac{{F}_{2}}{M} sin ( {θ}_{e} - Φ ) \\ ( {F}_{1} sin ( {θ}_{e} - Φ ) + {F}_{2} cos ( {θ}_{e} - Φ ) \frac{L}{I} )\end{matrix} ] .$$

I is a moment of inertia of the mobile robot, and De is an angle of the mobile robot in the pedestrian coordinate system. A front following function, a rear following function, and a side following function of the mobile robot relative to the single one of the one or more pedestrian targets can be achieved by controlling a real-time angle Φ between the mobile robot and the single one of the one or more pedestrian targets to tend to θₑ using the following motion controller.

Specifically, the mobile robot can have functional modules, such as autonomous navigation, human-computer interaction control, automatic charging, and one-key homing. Tasks such as the better tracking, the obstacle avoidance, and the path planning can be achieved by integrating the wireless electromagnetic tracking technologies with the visible light camera, the infrared thermal imaging, the lidar, the millimeter-wave radar, the ultrasonic arrays, etc. The mobile robot can predict a movement direction of the one or more pedestrian targets through perception information and algorithms such as Markov to improve a following stability and reliability.

Step 4. Finding an average value of the position and orientation information of multiple of the one or more receiving modules relative to the transmitting module, and following multiple of the one or more pedestrian targets using the linear acceleration and angular acceleration of the mobile robot obtained by calculating using the following motion control algorithm of the mobile robot based on the average value when the mobile robot is determined to be in the multi-person following mode.

In a specific embodiment, the step 4 specifically comprises:

Repeating the step 31, respectively obtaining the corresponding one of the one or more distances d and the corresponding one of the one or more angles Φ between the corresponding one of the one or more receiving modules on each of the multiple of the one or more pedestrian targets and the transmitting module by calculating, obtaining an average angle by deriving an average value of the angles Φ, and repeating steps 32 and 33 to realize a front following function, a rear following function, and a side following function of the multiple of the one or more pedestrian targets based on the average angle.

Specifically, each of the multiple of the one or more pedestrian targets wears the corresponding one of the one or more receiving modules. A number of the one or more receiving modules worn by the multiple of the one or more pedestrian targets is 1, 2, . . . , N.

Step 41, a state vector of the mobile robot in the world coordinate system is computed as follows:

xᵣ^{W}=[xᵣ yᵣ θᵣ]^{T}.

A state vector of a first one of the multiple of the one or more pedestrian targets in the world coordinate system is computed as follows:

xₕ₁^{W}=[xₕ₁ yₕ₁ θₕ₁]^{T}.

A state vector of an Nth one of the multiple of the one or more pedestrian targets in the world coordinate system is computed as follows:

x_{hN}^{W}=[x_{hN} y_{hN} θ_{hN}]^{T}.

A state vector of the mobile robot in the pedestrian coordinate system is expressed as:

xₑ^{H}=[xₑ yₑ θₑ]^{T}.

An angle of the mobile robot converted from the world coordinate system to a coordinate system of the first one of the multiple of the one or more pedestrian targets is calculated as follows:

$${x}_{r}^{H} = F ( {x}_{r}^{W} - {x}_{h 1}^{W} - {[ \begin{matrix}0 & 0 & {θ}_{sh}\end{matrix} ]}^{T} ) .$$

An angle of the mobile robot converted from the world coordinate system to a coordinate system of the Nth one of the multiple of the one or more pedestrian targets is calculated as follows:

$${x}_{r}^{H} = F ( {x}_{r}^{W} - {x}_{hN}^{W} - {[ \begin{matrix}0 & 0 & {θ}_{sh}\end{matrix} ]}^{T} ) .$$

A conversion matrix F is determined as follows:

$$F = [ \begin{matrix}cos ( {θ}_{h} + {θ}_{sh} ) & sin ( {θ}_{h} + {θ}_{sh} ) & 0 \\ - sin ( {θ}_{h} + {θ}_{sh} ) & cos ( {θ}_{h} + {θ}_{sh} ) & 0 \\ 0 & 0 & 1\end{matrix} ] .$$

The one or more distances d and the one or more angles Φ between the one or more receiving modules and the transmitting module are obtained by calculating using the following motion control algorithm of the mobile robot according to the state vector of the mobile robot in the pedestrian coordinate system.

In the following motion control algorithm of the mobile robot, a position and orientation relationship between the mobile robot and the multiple of the one or more pedestrian targets is described through the force control algorithm of the virtual spring. The force control algorithm of the virtual spring assumes that there is a connection of the origin of the pedestrian coordinate system E and the coordinate of the mobile robot xᵣ^{H}=[xₑ yₑ θₑ]^{T} between the mobile robot and the multiple of the one or more pedestrian targets. For the Nth one of the multiple of the one or more pedestrian targets, the relaxation length of the virtual spring is the corresponding one of the one or more distances d between the mobile robot and the Nth one of the multiple of the one or more pedestrian targets, and the corresponding one of the one or more angles between the mobile robot and the Nth one of the multiple of the one or more pedestrian targets is Φ, which is expressed as follows:

$$\{ \begin{matrix}{d}_{N} = \sqrt{{x}_{e}^{2} - {y}_{e}^{2}} \\ {Φ}_{N} = arc tan \frac{{y}_{e}}{{x}_{e}}\end{matrix} .$$

Step 42, determining the quadrant information of the multiple of the one or more pedestrian targets relative to the mobile robot based on the one or more angles Φ between the one or more receiving modules and the transmitting module, and determining the following mode by the quadrant information:

$$Φ = \frac{{\sum }_{i = 1}^{N} {Φ}_{i}}{N} = \{ \begin{matrix}[ π / 4 , 3 π / 4 ] , rear follow mode \\ [ 3 π / 4 , π ] ⋃ [ - π , - 3 π / 4 ] , right follow mode \\ [ - 3 π / 4 , - π / 4 ] , front follow mode \\ [ - π / 4. ] ⋃ [ 0 , π / 4 ] , left follow mode\end{matrix} .$$

When Φ=[π/4, 3π/4], judging that the mobile robot is at the rear side of the multiple of the one or more pedestrian targets and triggering the rear follow mode in which the input linear acceleration aᵥ and the input angular acceleration a_{w} are controlled through the step 33 to enable Φ to tend to π/2.

When Φ=[3π/4, π]∪[−π, −3π/4], judging that the mobile robot is at the right side of the multiple of the one or more pedestrian targets and triggering the right follow mode in which the input linear acceleration aᵥ and the input angular acceleration a_{w} are controlled through the step 33 to enable Φ to tend to π.

When Φ=[−3π/4, −π/4], judging that the mobile robot is at the front side of the multiple of the one or more pedestrian targets and triggering the front follow mode in which the input linear acceleration aᵥ and the input angular acceleration a_{w} are controlled through the step 33 to enable Φ to tend to −π/2.

When Φ=[−π/4, 0]∪[0, π/4], judging that the mobile robot is at the left side of the multiple of the one or more pedestrian targets and triggering the left follow mode in which the input linear acceleration aᵥ and the input angular acceleration a_{w} are controlled through the step 33 to enable Φ to tend to 0;

Step 43, obtaining the input linear acceleration aᵥ and the input angular acceleration a_{w} by calculating using the following motion control algorithm of the mobile robot based on the relative position and orientation between the mobile robot and the multiple of the one or more pedestrian targets, the environmental perception information, and the human-computer interaction strategy. The following motion control algorithm of the mobile robot comprises the force control algorithm of the virtual spring, the social force model/impedance control algorithm, the model predictive control algorithm, or the reinforcement learning algorithm.

Specifically, FIG. 8 illustrates four following modes for two of the multiple of the one or more pedestrian targets. For the following mode for the multiple of the one or more pedestrian targets, a center point of a coordinate between a leftmost one and a rightmost one in the multiple of the one or more pedestrian targets is exactly adjusted to be located on an axis of the mobile robot.

In the following method of the mobile robot based on the electromagnetic positioning in the embodiment of the present disclosure, the following between the mobile robot and the multiple of the one or more pedestrian targets can be achieved through a wireless electromagnetic positioning tracking device. Position and orientation tracking with 360 degrees, millimeter-level, and a wide scope is achieved using the wireless electromagnetic tracking technologies to overcome an influence of optical obstacles applied on the optical imaging module and deficiencies of ultra-wideband (UWB) in accuracy and non-360-degree tracking. The front following mode, the rear following mode, the side following mode, the single-person following mode, the multi-person following mode, and adaptive switching thereof are then executed through the environmental perception and the following motion control algorithm to achieve intelligent following applications in different application scenarios.

Further, referring to FIG. 9, as an implementation of the methods shown in the aforementioned various drawings, the present disclosure provides an embodiment of the following device of the mobile robot based on the electromagnetic positioning. The following device in this embodiment performs the method shown in FIG. 2, and the device can be specifically applied to various electronic devices.

This embodiment of the present disclosure provides the following device of the mobile robot based on the electromagnetic positioning. The following device comprises a position and orientation information acquisition module 1, a following mode determination module 2, a single-person following control module 3, and a multi-person following control module 4.

The position and orientation information acquisition module 1 is configured to acquire the electromagnetic signals sent to the one or more receiving modules located on the one or more pedestrian targets from the transmitting module located on the mobile robot and to obtain the position and orientation information of the one or more receiving modules relative to the transmitting module by calculating using the electromagnetic positioning algorithm based on the electromagnetic signals.

The following mode determination module 2 is configured to determine whether the mobile robot is in the single-person following mode or the multi-person following mode based on the number of the connection signals of the one or more receiving modules connected to the transmitting module.

The single-person following control module 3 is configured to follow the single one of the one or more pedestrian targets using the linear acceleration and the angular acceleration of the mobile robot obtained by calculating using the following motion control algorithm of the mobile robot based on the position and orientation information of the one or more receiving modules relative to the transmitting module when the mobile robot is determined to be in the single-person following mode.

The multi-person following control module 4 is configured to find the average value of the position and orientation information of the multiple of the one or more receiving modules relative to the transmitting module and follow the multiple of the one or more pedestrian targets using the linear acceleration and the angular acceleration of the mobile robot by calculating using the following motion control algorithm of the mobile robot based on the average value when the mobile robot is determined to be in the multi-person following mode.

Furthermore, this embodiment of the present disclosure also provides the following system of the mobile robot based on electromagnetic positioning. The following system comprises the following modules: the transmitting module, the one or more receiving modules, and control modules (e.g., the single-person following control module 3 and the multi-person following control module 4) of the mobile robot. The transmitting module comprises an electromagnetic transmitter and a transmitting coil group. The one or more receiving modules comprise one or more receiving coil groups. Each of the control modules of the mobile robot comprises a control development board, a servo motor, and a motor driver. The control development board comprises the following device of the mobile robot based on the electromagnetic positioning to execute the specific steps of the following method of the mobile robot based on the electromagnetic positioning.

Furthermore, the transmitting module, the one or more receiving modules, and the control modules of the mobile robot are connected through wireless communication modes, such as Bluetooth, Zigbee, and WiFi.

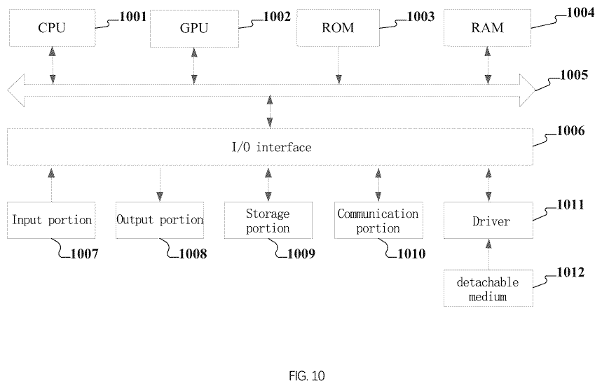

FIG. 10 illustrates a structural diagrammatic view of a computer device 1000 of an electronic device (such as the server or the terminal devices shown in FIG. 1) suitable for implementing an embodiment of the present disclosure. The electronic device shown in FIG. 10 is only an example, and a function and an application scope of the embodiment of the present disclosure should not be limited thereto.

As shown in FIG. 10, the computer device 1000 comprises a central processing unit (CPU) 1001 and a graphics processing unit (GPU) 1002. The CPU 1001 and the GPU 1002 can perform various appropriate actions and processes based on a program stored in a read-only memory (ROM) 1003 or a program loaded to a random access memory (RAM) 1004 from a storage part 1009. Various programs and data required for the operation of the device 1000 are also stored in the RAM 1004. The CPU 1001, the GPU 1002, the ROM 1003, and the RAM 1004 are connected to each other via a bus 1005. Input/output (I/O) interfaces 1006 are also connected to the bus 1005.

The following components are connected to the I/O interfaces 1006: an input portion 1007 comprising a keyboard, a mouse, etc.; an output portion 1008 comprising a liquid crystal display (LCD), etc. and a speaker, etc.; a storage portion 1009 comprising a hard disk, etc.; and a communication portion 1010 comprising a network interface card, such as a Local Area Network (LAN) card, a modem, etc. The communication portion 1010 performs communication processes via a network such as the Internet. A drive 1011 can also be connected to the I/O interfaces 1006 as needed. A removable medium 1012, such as a magnetic disk, an optical disk, a magneto-optical disk, a semiconductor memory, is installed on the drive 1011 as needed, so that a computer program read therefrom is installed into the storage portion 1009 as needed.

In particular, according to the embodiment of the present disclosure, the process described above with reference to the flowchart can be implemented as a computer program. For example, the embodiment of the present disclosure comprises a product of the computer program comprising a computer program loaded on a computer-readable medium (e.g., a non-transitory computer-readable storage medium), and the computer program comprises program codes for executing the method shown in the flowchart. In this embodiment, the computer program can be downloaded from the network through the communication portion 1010 to be installed and/or installed from the removable medium 1012. When the computer program is executed by the CPU 1001 and the GPU 1002, the aforementioned functions defined in the method of the present disclosure are executed.

It should be noted that the computer-readable medium described in the present disclosure can be a computer-readable signal medium, a computer-readable medium, or any combination of the computer-readable signal medium and the computer-readable medium. The computer-readable medium can be a device or an element of electricity, magnetism, light, electromagnetism, infrared light, or semiconductor, or any combination of the device and the element but is not limited thereto. More specific examples of the computer-readable medium can comprise at least one of an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, or a magnetic storage device but is not limited thereto. In the present disclosure, the computer-readable medium can be any tangible medium containing or storing the computer program, and the computer program can be used by at least one of an instruction execution device, a device, or an element. In the present disclosure, the computer-readable signal medium can comprise a data signal in a baseband or propagated as a part of a carrier wave, and the computer-readable signal medium carries computer-readable program codes. These propagated data signals can adopt various forms, and the various forms comprise at least one of electromagnetic signals or optical signals but are not limited thereto. The computer-readable signal medium can also be any readable medium other than the computer-readable medium, and the readable medium can send, propagate, or transmit the computer program used by at least one of the instruction execution device, the device, or the element. The computer program codes contained on the computer-readable medium can be transmitted using any suitable medium, and the suitable medium comprises at least one of wireless, wire, optical cable, Radio Frequency (RF), etc. but is not limited thereto.

The computer program codes for performing operations of the present disclosure can be written in one or more programming languages or a combination thereof. The one or more programming languages comprises object-oriented programming languages, such as Java, Smalltalk, C++, and conventional procedural programming languages, such as “C” languages or similar programming languages. The program codes can be executed entirely on a computer of the user, executed partially on the computer of the user, executed as a separate software package, executed partially on the computer of the user and partially on a remote computer, or executed entirely on the remote computer or the server. In a case of the remote computer involved, the remote computer can be connected to the computer of the user through any type of network. The network comprises a local area network (LAN) or a wide area network (WAN), or the remote computer can be connected to an external computer (e.g., connected through the Internet using an Internet service provider).

The flowcharts and the block diagrams in the accompanying drawings illustrate possible architecture, functions, and operations implemented by the devices, the methods, and the product of the computer program of various embodiments of the present disclosure. Therefore, each block in the flowcharts or the block diagrams can represent a module, a program segment, or a portion of codes. The module, the program segment, or the portion of the codes comprises one or more executable instructions for implementing a specified logical function. It should also be noted that in some alternative implementations, the functions marked in blocks can also occur in a sequence different from that in the accompanying drawings. For example, two blocks represented in sequence can actually be executed substantially in parallel or can sometimes be executed in a reverse sequence, which depends on the functions involved. It should also be noted that each block in the block diagrams and/or the flowcharts and a combination of the blocks in the block diagrams and/or the flowcharts can be implemented by a specified hardware-based device that executes a specified function or operation or can be implemented by a combination of a specified hardware and computer instructions.

The modules involved in the embodiments of the present disclosure can be implemented by the software or by the hardware. The described modules can also be disposed in the processor.

As another aspect, the present disclosure further provides the computer-readable medium. The computer-readable medium can be included in the electronic device described in the aforementioned embodiments, or the computer-readable medium can exist independently without being assembled into the electronic device. The computer-readable medium carries one or more computer programs. When the one or more computer programs are executed by the electronic device, the electronic device executes the following steps: acquiring the electromagnetic signals sent to the one or more receiving modules located on the one or more pedestrian targets by the transmitting module located on the mobile robot, and obtaining the position and orientation information of the one or more receiving modules relative to the transmitting module by calculating using the electromagnetic positioning algorithm based on the electromagnetic signals; determining whether the mobile robot is in the single-person following mode or the multi-person following mode based on the number of the connection signals of the one or more receiving modules connected to the transmitting module; following the single one of the one or more pedestrian targets using the linear acceleration and the angular acceleration of the mobile robot obtained by calculating using the following motion control algorithm of the mobile robot based on the position and orientation information of the one or more receiving modules relative to the transmitting module when the mobile robot is determined to be in the single-person following mode; finding the average value of the position and orientation information of the multiple of the one or more receiving modules relative to the transmitting module and following the multiple of the one or more pedestrian targets using the linear acceleration and the angular acceleration of the mobile robot obtained by calculating using the following motion control algorithm of the mobile robot based on the average value when the mobile robot is determined to be in the multi-person following mode.

The preceding description is only preferred embodiments of the present disclosure and an explanation of the technical principles used. Those of skill in the art should understand that the scope involved in the present disclosure is not limited to the technical solutions formed by a specified combination of the aforementioned technical features. The scope involved in the present disclosure should also cover other technical solutions formed by any combination of the aforementioned technical features or equivalent features thereof without departing from the concepts of the present disclosure. For example, technical solutions in which the aforementioned features are replaced with (but not limited to) technical features with similar functions disclosed in this present disclosure

What is claimed is:

1. A following method of a mobile robot based on electromagnetic positioning, comprising:
step 1. acquiring electromagnetic signals sent to one or more receiving modules located on one or more pedestrian targets by a transmitting module located on the mobile robot, and obtaining position and orientation information of the one or more receiving modules relative to the transmitting module by calculating through an electromagnetic positioning algorithm based on the electromagnetic signals;
step 2. determining whether the mobile robot is in a single-person following mode or a multi-person following mode based on a number of connection signals of the one or more receiving modules connected to the transmitting module;
step 3. following a single one of the one or more pedestrian targets using a linear acceleration and an angular acceleration of the mobile robot obtained by calculating using a following motion control algorithm of the mobile robot based on the position and orientation information of the one or more receiving modules relative to the transmitting module when the mobile robot is determined to be in the single-person following mode; and
step 4. finding an average value of the position and orientation information of multiple of the one or more receiving modules relative to the transmitting module and following multiple of the one or more pedestrian targets using the linear acceleration and the angular acceleration of the mobile robot obtained by calculating using the following motion control algorithm of the mobile robot based on the average value when the mobile robot is determined to be in the multi-person following mode.

2. The method according to claim 1, wherein:
the step 1 comprises:
defining a center of the transmitting module as an origin of a coordinate system of the transmitting module, obtaining three orthogonal magnetic induction intensity components (Bₓ, B_{y}, B_{z}) by measuring through the one or more receiving modules, wherein a coordinate system of the one or more receiving modules is parallel to three coordinate axes of the coordinate system of the transmitting module, and obtaining a first target coordinate system (u, v, w) by rotating a second target coordinate system (x, y, z) around an x-axis, a y-axis, and a z-axis by Euler angles α, β, and γ respectively, wherein a rotation direction is counterclockwise from top to bottom in each of the x-axis, the y-axis, and the z-axis;
obtaining the three orthogonal magnetic induction intensity components (Bₓ, B_{y}, B_{z}) by calculating based on a magnetic dipole model:
$$\{ \begin{matrix}{B}_{x} = {B}_{T} \{ 3 x ( mx + ny + pz ) / {r}^{5} - m / {r}^{3} \} \\ {B}_{y} = {B}_{T} \{ 3 y ( mx + ny + pz ) / {r}^{5} - n / {r}^{3} \} \\ {B}_{z} = {B}_{T} \{ 3 z ( mx + ny + pz ) / {r}^{5} - p / {r}^{3} \}\end{matrix} ;$$
wherein B_{T} is a constant, B_{T}=μIR²/4, μ is a magnetic permeability of air, I is magnitude of current, R is a radius of one or more coils of the transmitting module, (m, n, p) are unit direction vectors of the transmitting module, m²+n²+p²=1, r is a distance from the one or more receiving modules to the transmitting module, and r=\sqrt{x²+y²+z²};
obtaining magnetic induction intensity components (Bᵤ, Bᵥ, B_{w}) induced by the one or more receiving modules in the first target coordinate system (u, v, w) based on the three orthogonal magnetic induction intensity components (Bₓ, B_{y}, B_{z}) by calculating:
(Bᵤ,Bᵥ,B_{w})^{T}=R(Bₓ,B_{y},B_{z})^{T};
wherein R is the Euler angle, and a rotation process is described as follows:
R=Rot(z,γ)Rot(y,β)Rot(x,α)
wherein Rot(z, γ) is rotating around the z axis by an angle γ, Rot(y, β) is rotating around the y axis by an angle β, and Rot(x, α) is rotating around the x axis by an angle α; and
obtaining the position and orientation information of the one or more receiving modules relative to the transmitting module through the electromagnetic positioning algorithm by calculating based on the magnetic induction intensity components (Bᵤ, Bᵥ, B_{w}) induced by the one or more receiving modules in the first target coordinate system (u, v, w).

3. The method according to claim 1, wherein the electromagnetic positioning algorithm comprises an optimization algorithm, an analytical method, or a wireless tracking algorithm based on a neural network.

4. The method according to claim 1, wherein the step 2 comprises:
determining whether the mobile robot is in the single-person following mode or the multi-person following mode by checking the number of the connection signals of the one or more receiving modules connected to the transmitting module;
when the number of the connection signals is 1, determining that the mobile robot is in the single-person following mode and executing the step 3; and
when the number of the connection signals is greater than 1, determining that the mobile robot is in the multi-person following mode, and executing the step 4.

5. The method according to claim 1, wherein the step 3 comprises:
step 31. computing a state vector of the mobile robot in a world coordinate system as follows:
xᵣ^{W}=[xᵣ yᵣ θᵣ]^{T};
computing a state vector of the one or more pedestrian targets in the world coordinate system as follows:
xₕ^{W}=[xₕ yₕ θₕ]^{T};
computing a state vector of the mobile robot in a pedestrian coordinate system as follows:
xᵣ^{H}=[xₑ yₑ θₑ]^{T};
calculating an angle of the mobile robot converted from the world coordinate system to the pedestrian coordinate system as follows:
$${x}_{r}^{H} = F ( {x}_{r}^{W} - {x}_{h}^{W} - {[ \begin{matrix}0 & 0 & {θ}_{sh}\end{matrix} ]}^{T} ) ;$$
determining a conversion matrix F as follows:
$$F = [ \begin{matrix}cos ( {θ}_{h} + {θ}_{sh} ) & sin ( {θ}_{h} + {θ}_{sh} ) & 0 \\ - sin ( {θ}_{h} + {θ}_{sh} ) & cos ( {θ}_{h} + {θ}_{sh} ) & 0 \\ 0 & 0 & 1\end{matrix} ] ;$$
obtaining one or more distances d and one or more angles Φ between the one or more receiving modules and the transmitting module by calculating using the following motion control algorithm of the mobile robot based on the state vector of the mobile robot in the pedestrian coordinate system;
step 32. judging quadrant information of the single one of the one or more pedestrian targets relative to the mobile robot based on a corresponding one of the one or more angles Φ between a corresponding one of the one or more receiving modules and the transmitting module, and judging a following mode by the quadrant information:
$$Φ = \frac{{\sum }_{j = 1}^{N} {Φ}_{i}}{N} = \{ \begin{matrix}[ π / 4 , 3 π / 4 ] , rear follow mode \\ [ 3 π / 4 , π ] ⋃ [ - π , - 3 π / 4 ] , right follow mode \\ [ - 3 π / 4 , - π / 4 ] , front follow mode \\ [ - π / 4. ] ⋃ [ 0 , π / 4 ] , left follow mode\end{matrix} ;$$
when Φ=[π/4, 3π/4], judging that the mobile robot is at a rear side of the single one of the one or more pedestrian targets and triggering a rear following mode in which an input linear acceleration aᵥ and an input angular acceleration a_{w} are controlled by a step 33 to enable Φ to tend to π/2;
when Φ=[3π/4, π]∪[−π, −3π/4], judging that the mobile robot is at a right side of the single one of the one or more pedestrian targets and triggering a right following mode in which the input linear acceleration aᵥ and the input angular acceleration a_{w} are controlled by the step 33 to enable Φ to tend to x;
when Φ=[−3π/4, −π/4], judging that the mobile robot is at a front side of the single one of the one or more pedestrian targets and triggering a front following mode in which the input linear acceleration aᵥ and the input angular acceleration a_{w} are controlled by the step 33 to enable Φ to tend to −π/2;
when Φ=[−π/4, 0]∪[0, π/4], judging that the mobile robot is at a left side of the single one of the one or more pedestrian targets and triggering a left following mode in which the input linear acceleration aᵥ and the input angular acceleration a_{w} are controlled by the step 33 to enable Φ to tend to 0;
step 33. obtaining the input linear acceleration aᵥ and the input angular acceleration a_{w} by calculating using the following motion control algorithm of the mobile robot based on a relative position and orientation between the mobile robot and the single one of the one or more pedestrian targets, an environmental perception information, and a human-computer interaction strategy, wherein the following motion control algorithm of the mobile robot comprises a force control algorithm of a virtual spring, a social force model/impedance control algorithm, a model predictive control algorithm, or a reinforcement learning algorithm.

6. The method according to claim 5, wherein:
when the following motion control algorithm of the mobile robot adopts the force control algorithm of the virtual spring, assume that there is a connection of an origin of the pedestrian coordinate system and a coordinate of the mobile robot between the mobile robot and the corresponding one of the one or more pedestrian targets xᵣ^{H}=[xₑ yₑ θₑ]^{T}, a relaxation length of the virtual spring is a corresponding one of the one or more distances d between the mobile robot and the corresponding one of the one or more receiving modules, and a corresponding one of the one or more angles between the mobile robot and the corresponding one of the one or more receiving modules are Φ, which is illustrated as follows:
$$\{ \begin{matrix}d = \sqrt{{x}_{e}^{2} - {y}_{e}^{2}} \\ Φ = arc tan \frac{{y}_{e}}{{x}_{e}}\end{matrix} ;$$
the method comprises describing a following relationship between the mobile robot and the single one of the one or more pedestrian targets as a force of the virtual spring, and obtaining a virtual tensile and compressive deformation elastic force F₁ and a virtual bending deformation elastic force F₂ by calculating:
$$\{ \begin{matrix}{F}_{1} = {k}_{1} ( d - {l}_{0} ) \\ {F}_{2} = {k}_{2} / Φ\end{matrix} ;$$
k₁ is an elastic coefficient of the virtual spring with units in N/m, k₂ is a curvature coefficient of the virtual spring with units in N/rad, and l₀ is an initial length of the virtual spring with units in m;
a dynamic equation of the following motion control is illustrated as follows:
$$\{ \begin{matrix}{Ma}_{v} = - {F}_{1} cos ( {θ}_{e} - Φ ) - {F}_{2} sin ( {θ}_{e} - Φ ) - {k}_{3} v \\ {Ma}_{ω} = ( {F}_{1} sin ( {θ}_{e} - Φ ) + {F}_{2} cos ( {θ}_{e} - Φ ) - {k}_{4} ω ) L\end{matrix} ;$$
M is a mass of the mobile robot with units in Kg, k₃ is a translational damping coefficient with units in Ns/m, and k₄ is a rotational damping coefficient with units in Ns/rad;
a following motion controller is illustrated as follows:
$$[ \begin{matrix}{a}_{v} \\ {a}_{ω}\end{matrix} ] = [ \begin{matrix}- \frac{{k}_{3}}{M} & 0 \\ 0 & - \frac{{k}_{4} L}{I}\end{matrix} ] [ \begin{matrix}v \\ ω\end{matrix} ] + [ \begin{matrix}- \frac{{F}_{1}}{M} cos ( {θ}_{e} - Φ ) - \frac{{F}_{2}}{M} sin ( {θ}_{e} - Φ ) \\ ( {F}_{1} sin ( {θ}_{e} - Φ ) + {F}_{2} cos ( {θ}_{e} - Φ ) \frac{L}{I} )\end{matrix} ] ;$$
I is a moment of inertia of the mobile robot, De is an angle of the mobile robot in the pedestrian coordinate system, and a front following function, a rear following function, and a side following function of the mobile robot relative to the single one of the one or more pedestrian targets is configured to be achieved by controlling a real-time angle Φ between the mobile robot and the single one of the one or more pedestrian targets to tend to De using the following motion controller.

7. The method according to claim 5, wherein:
the step 4 comprises:
repeating the step 31, respectively obtaining the corresponding one of the one or more distances d and the corresponding one of the one or more angles Φ between the corresponding one of the one or more receiving modules on each of the multiple of the one or more pedestrian targets and the transmitting module by calculating, obtaining an average angle by deriving an average value, and repeating steps 32 and 33 to realize a front following function, a rear following function, and a side following function of the multiple of the one or more pedestrian targets based on the average angle.

8. A following device of a mobile robot based on electromagnetic positioning, comprising:
a position and orientation information acquisition module,
a following mode determination module,
a single-person following control module, and
a multi-person following control module, wherein:
the position and orientation information acquisition module is configured to acquire electromagnetic signals sent to one or more receiving modules located on one or more pedestrian targets from a transmitting module located on the mobile robot and to obtain position and orientation information of the one or more receiving modules relative to the transmitting module by calculating using an electromagnetic positioning algorithm based on the electromagnetic signals,
the following mode determination module is configured to determine whether the mobile robot is in a single-person following mode or a multi-person following mode based on a number of connection signals of the one or more receiving modules connected to the transmitting module,
the single-person following control module is configured to follow a single one of the one or more pedestrian targets using a linear acceleration and an angular acceleration of the mobile robot obtained by calculating using a following motion control algorithm of the mobile robot based on position and orientation information of the one or more receiving modules relative to the transmitting module when the mobile robot is determined to be in the single-person following mode, and
the multi-person following control module is configured to find an average value of the position and orientation information of multiple of the one or more receiving modules relative to the transmitting module and follow multiple of the one or more pedestrian targets using the linear acceleration and the angular acceleration of the mobile robot obtained by calculating using the following motion control algorithm of the mobile robot based on the average value when the mobile robot is determined to be in the multi-person following mode.

9. The following device of the mobile robot based on the electromagnetic positioning according to claim 8, wherein:
the transmitting module adopts a single-axis to multi-axis coil mode, and
the one or more receiving modules adopt a corresponding multi-axis to single-axis coil mode.

10. The following device of the mobile robot based on the electromagnetic positioning according to claim 8, wherein the electromagnetic positioning algorithm comprises an optimization algorithm, an analytical method, or a wireless tracking algorithm based on a neural network.

11. An electronic device, comprising:
one or more processors, and
a storage device for storing one or more computer programs, wherein:
when the one or more computer programs are executed by the one or more processors, the method according to claim 1 is implemented by the one or more processors.

12. A non-transitory computer-readable storage medium, wherein:
a computer program is stored on the non-transitory computer-readable storage medium, and
the method according to claim 1 is implemented when the computer program is executed by a processor.

13. The following device of the mobile robot based on the electromagnetic positioning according to claim 9, wherein the electromagnetic positioning algorithm comprises an optimization algorithm, an analytical method, or a wireless tracking algorithm based on a neural network.
